(19) United States
(12) Patent Application Publication
(10) Pub. No.: US 2026/0072642 A1
(43) Pub. Date: Mar. 12, 2026

(54) SYSTEMS AND METHODS FOR MERGING DATA SETS

(71) Applicant: Truist Bank, Charlotte, NC (US)

(72) Inventors: Kathy McLaughlin Gardner, Greensboro, NC (US); Ganesh Kumar Thandavarayan, Apex, NC (US)

(73) Assignee: Truist Bank, Charlotte, NC (US)

(21) Appl. No.: 18/828,158

(22) Filed: Sep. 9, 2024

(51) Int. Cl. G06F 7/14; G06F 16/25

(52) U.S. Cl. CPC G06F 7/14; G06F 16/258

(57) ABSTRACT

A computing system merges data sets associated with user groups a combined data set. Each data set is associated with a unique user group. The combined data set is associated with a target user group including subsets of the user groups. The computing system performs steps including: configuring data content of each data set of the multiple data sets into the target data format; automatically evaluating the data sets to automatically postulate whether one or more users of the target user group are common to more than one of the subsets of users; and automatically transmitting a notification signal to the one or more agent device upon at least one of: postulating one or more users of the target user group are common to more than one of the subsets of users; and completion of generating the combined data set in the target data.

### TECHNICAL FIELD

The present disclosure relates generally to automated data set mergers, and more particularly to combining data sets of multiple user groups while identifying any common users among the groups.

### BACKGROUND

User groups representing companies and/or departments thereof are subject to transitions such as mergers, acquisitions, and growth. Information and account continuity is of utmost importance for work efficiency and continuing business success. Expediency and efficacy are needing in transitioning group configurations, with regard to accounts, software, social media, digital content by which services providers conduct business, user contact information, and other stored content. A service provider having previous engagement with a pre-transition entity is better positioned to maintain a service relationship with a post-transition entity by facilitating the transition. Proven tools and streamlined approaches to assisting parties through transitions would be beneficial to clients.

Improvements are needed for automating data set mergers, and more particularly to combining data sets of multiple user groups while identifying any common users among the groups.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment each, a system and a method are provided for merging multiple data sets associated with respective multiple user groups by summation and transformation into a combined data set in a target data format, each data set of multiple data sets being associated with a respective unique one user group of the multiple user groups, the combined data set associated with a target user group including subsets of users, each subset of users being a subset of one user group of the multiple user groups. The system includes: a computing system including one or more processor configured to execute computer-readable instructions, at least one of a memory device and a non-transitory storage device, and a communication interface for operatively connecting, via a communication network, the one or more processor to one or more agent device. Upon execution of the computer-readable instructions, the computing system performs steps including: configuring data content of each data set of the multiple data sets into the target data format; automatically evaluating the data content of each data set of the multiple data sets to automatically postulate whether one or more users of the target user group are common to more than one of the subsets of users; generating a combined data set in the target data format by adding at least some data content of each data set in the target data format into the combined data set; and automatically transmitting a notification signal to the one or more agent device upon at least one of: postulating one or more users of the target user group are common to more than one of the subsets of users; and completion of generating the combined data set in the target data format.

In at least one example, generating the combined data set in the target data format by adding at least some data content of each data set in the target data format into the combined data set includes, for each unique user of the target user group, at least one of creating or maintaining a user-specific profile, the user-specific profile associating the unique user with at least one of an application, a file, a database, and a link register.

Evaluating the data content of each data set of the multiple data sets may further include, for each user automatically postulated as common to more than one of the subsets of users, determining whether the user postulated as common is common to more than one of the subsets, the determining including at least one of: transmitting a confirmation request to a user device associated with the user postulated as common via at least one contact channel defined by at least one data set of the multiple data sets; comparing at least two of first name, last name, and email address stored in at least two data sets of the multiple data sets; and transmitting a confirmation request to a user device associated with an authorized administrator via at least one contact channel defined by at least one data set of the multiple data sets.

In some examples, when evaluating the data content of each data set of the multiple data sets determines one or more users of the target user group are common to more than one of the subsets of users, creating or maintaining a user-specific profile for each unique user of the target user group includes, for each one user of the one or more users determined common, creating or maintaining a single user-specific profile.

The single user-specific profile may include at least one of an application, a file, a database, and a link register from each data set associated with the user group of each subset of users to which said one user is determined common.

The generated combined data set in the target data format may include a user-specific profile for each user of the target user group.

The user-specific profile created or maintained for each unique user of the target user group may include a user identification code unique to the unique user.

In at least one embodiment, a system for merging at least a first data set associated with a first user group and a second data set associated with a second user group into a combined data set associated with a target user group including at least a subset the first user group and a subset of the second user group. The system includes a computing system of a first entity including one or more processor configured to execute computer-readable instructions, at least one of a memory device and a non-transitory storage device, and a communication interface for operatively connecting, via a communication network, the one or more processor to one or more agent device. Upon execution of the computer-readable instructions, the computing system performs steps including: configuring data content of the first data set and data content of the second data set, each into a target data format; automatically evaluating the first data set and second data set to determine whether a particular user of the target user group is common to the first user group and second user group; generating a combined data set in the target data format by adding at least some of the content of the first data set and some of the data content of the second data set in the target data format into the combined data set; and automatically transmitting a notification signal to the one or more agent device upon determining the particular user of the target user group is common to the first user group and second user group.

In at least one example, generating the combined data set in the target data format by adding at least some of the content of the first data set and some of the data content of the second data set includes, for each unique user of the target user group, at least one of creating or maintaining a user-specific profile, the user-specific profile associating the unique user with at least one of an application, a file, a database, and a link register.

In at least one example, evaluating the first data set and second data set to determine whether the particular user of the target user group is common to the first user group and the second user group includes at least one of: transmitting a confirmation request to a user device associated with the particular user via at least one contact channel defined by at least one of the first data set and the second data set; comparing at least two of first name, last name, and email address stored in the first data set and the second data set; and transmitting a confirmation request to a user device associated with an authorized administrator via at least one contact channel defined by at least one the first data set and the second data set.

When evaluating the first data set and the second data set determines the particular user of the target user group is common the first user group and second user group, creating or maintaining a user-specific profile for each unique user of the target user group may include, for the particular user, creating or maintaining a single user-specific profile.

The single user-specific profile may include: at least one of an application, a file, a database, and a link register from the first data set and associated with the particular user; and at least one of an application, a file, a database, and a link register from the second data set and associated with the particular user.

The generated combined data set in the target data format may include a user-specific profile for each user of the target user group.

The user-specific profile created or maintained for each unique user of the target user group may include a user identification code unique to the unique user.

The above summary is to be understood as cumulative and inclusive. The above described embodiments and features are combined in various combinations in whole or in part in one or more other embodiments.

### BRIEF DESCRIPTION OF THE FIGURES

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates a system for at least for merging multiple data sets, and an environment thereof, in accordance with various embodiments.

FIG. 2 shows the system of FIG. 1, in abbreviated illustration, merging multiple data sets, in accordance with at least one embodiment.

FIG. 3 is a flowchart representation of a method for merging multiple data sets, according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to illustrations and/or block diagrams of systems and apparatuses (the term “apparatus” includes systems and computer program products), will be understood such that each function described or implied with reference to the illustrations and/or block diagrams, can be implemented by computer program instructions. These computer program instructions may be provided to a processor of a general-purpose computer, special-purpose computer, or other programmable data processing apparatus to produce a particular machine, such that the instructions, which execute via the processor of the computer or other programmable data processing apparatus, create mechanisms for implementing the functions/acts described, illustrated, and/or implied.

These computer program instructions may also be stored in a computer-readable memory that can direct a computer or other programmable data processing apparatus to function in a particular manner, such that the instructions stored in the computer readable memory produce an article of manufacture including instructions, which implement the function/act described, illustrated, and/or implied.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts described, illustrated, and/or implied. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

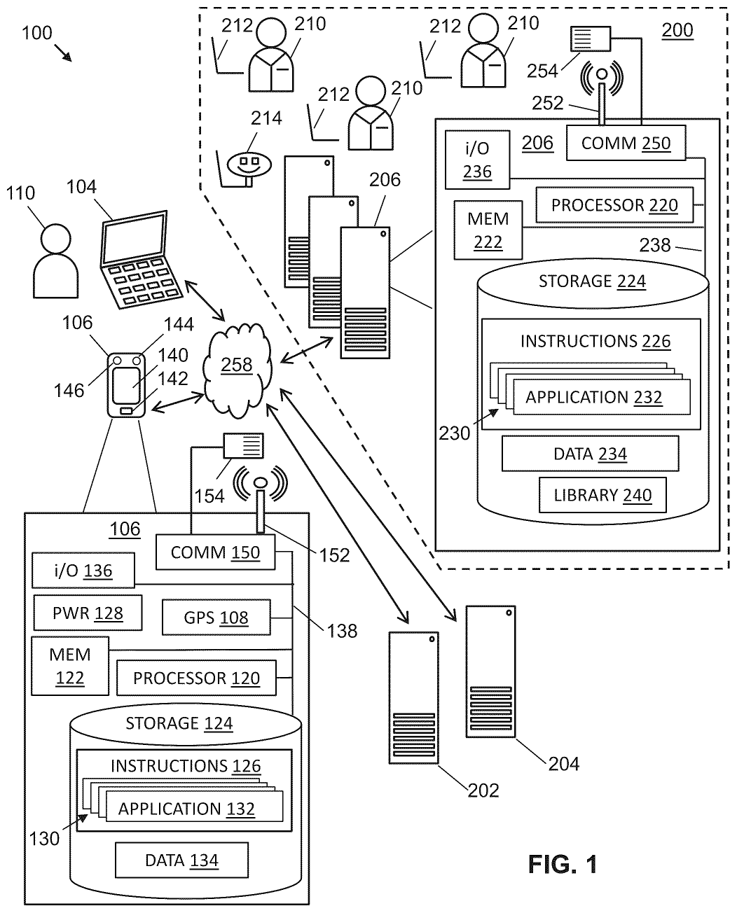

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1. Users 110 may utilize one or more user device, referring to either or both of the computing device 104 and the mobile device 106, each including or defining a user GUI, to conduct browsing or access of, for example, content stored and disseminated via library 240.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment of FIG. 1. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (Saas). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and Attorney hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third and fourth party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

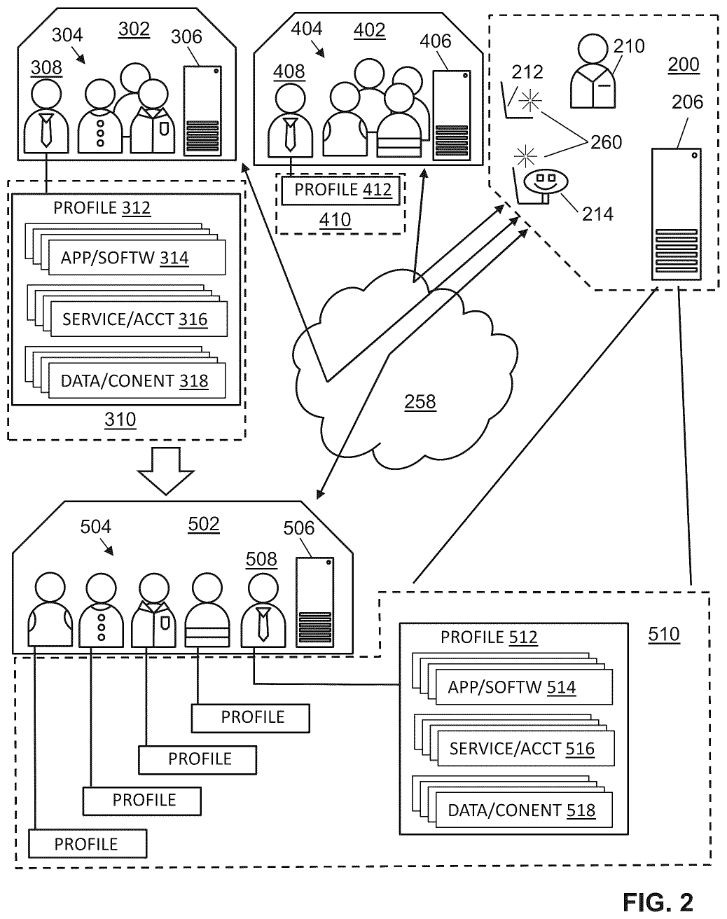

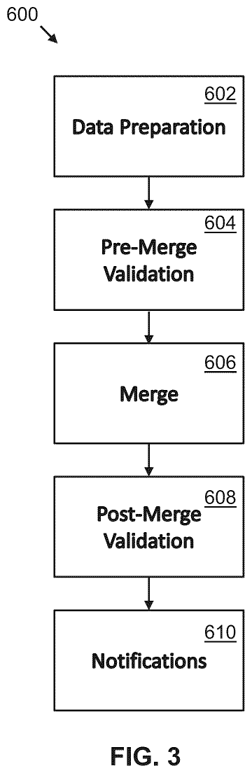

According to some embodiments of the above-described devices and systems, as further exemplified in FIGS. 2-3, in some embodiments, a system for merging multiple data sets is provided. The data sets are associated with respective multiple user groups. The initially separate data sets, which may be of different or same data formats are automatically processed by summation and transformation into a combined data set in a target data format. Each initial data set of multiple data sets is associated with a respective unique one user group of the multiple user groups. The combined data set is associated with a target user group including subsets of users, each subset of users being a subset of one user group of the multiple user groups.

In a non-limiting example of such embodiments, a merger of user groups represents a merger of work units representing businesses, such as when businesses merge, acquire or are acquired, or otherwise transition such that their employees, work groups, or other functional units are to be joined in part, restructured, expanded, or reduced. In some examples, a work group or business, at instances termed a user group herein, survives or continues through a transition. In some examples, a user group is dissolved. Any number of initial or pre-existing first user groups may enter a transitional phase or process and any number of resulting second user groups may continue. Through a transition such as a merger, in some cases some employees or a company involved are maintained and others are reduced. Thus, in some cases a subset or users of a pre-transition user group, representing employees of a pre-transition company, continue as users of a target user group, representing employees of a resulting post-transition company.

In the example illustrated in FIG. 2, two user groups (304, 404,) are transitioning into a single, combined, or merged target user group 504. The below descriptions related to a non-limiting example in which two companies are transitioning by merger into a single continuing company. These descriptions relate to other examples as well, for example non-limiting examples in which the referenced elements 302 and 402 are departments or divisions of a company.

A first pre-transition company 302 is illustrated as having a first pre-transition user group 304 representing employees or other interested and authorized parties. The first pre-transition company 302 is illustrated as having a computing system 306 in communication with the system 200 via the network 258. For the first pre-transition company 302, a pre-transition data set 310 is maintained, for example at and/or by the computing system 306. In an example in which the company 302 has pre-transition engagement with the host or first entity system 200, the pre-transition data set 310 may be maintained at and/or by the computing system 206.

A second pre-transition company 402 is illustrated (FIG. 2) as having a first pre-transition user group 404 representing employees or other interested and authorized parties. The second pre-transition company 402 is illustrated as having a computing system 406 in communication with the system 200 via the network 258. For the pre-transition company 402, a pre-transition data set 410 is similarly maintained, for example at and/or by the computing system 406 and/or at and/or by the computing system 206. Any number of pre-transition companies are represented in FIG. 2 by implication and logical extension, each one of which having a respective data set as represented for first pre-transition company 302 by the data set 310.

The system 200 is represented in abbreviated illustration in FIG. 2 for convenience to exemplify a system for merging multiple data sets. The system 200 accordingly, with respect to such embodiments descriptions of which herein in instances refer to elements of the drawings by reference numbers without limiting those descriptions to depicted elements, includes or constitutes a computing system 206 of a first entity including one or more processor 220 configured to execute computer-readable instructions 226, at least one of a memory device and a non-transitory storage device (222, 224 FIG. 1), and a communication interface for operatively connecting, via a communication network, the one or more processor to one or more agent device 212.

Upon execution of the computer-readable instructions, the computing system 200 performs steps including, for each data set of the multiple data sets (310, 410) configuring data content of each data set of the multiple data sets into the target data format. In a non-limiting example of a transition such as a merger or acquisition, the initial or pre-existing user groups being employees of a company subject to transition have, access, or utilize respective profiles, accounts, applications, contact lists, and other legacy content of originating pre-transition formats and these are configured into post-transition format according to a post-transition continuing company 502.

The company 502 is illustrated as having a post-transition or target user group 504 representing employees or other interested and authorized parties of the continuing company. The target user group 504 includes a subset of the user group 304, represented by foreground members in FIG. 2, and a subset of the user group 404, also represented by foreground members. Background members of the user groups 304 and 404 represent non-continuing users of the pre-transition companies (302, 402) for which profile creation or maintenance may not be needed with respect to the post-transition company 502. The post-transition company 502 is illustrated as having a computing system 506 in communication with the system 200 via the network 258. The computing system 506 represents in some embodiments new assets of the post-transition company, and continuing or accumulated assets (306, 406) of the pre-transition companies. The combined data set 510 is associated with the target user group 504, which includes subsets of users, each subset of users being a subset of one user group of the multiple user groups (304, 404).

In the absence of detected anomalies such as duplicate users among the continuing subsets of the user groups (304, 404), the combined data set 510 may represent the accumulation of the data sets 310 and 410.

The computing system further automatically evaluates the data content of each data set (310, 410) of the multiple data sets to automatically postulate whether one or more users of the target user group 504 are common to more than one of the subsets of users. For example, an automatic comparison is conducted in at least one embodiment of: user names; legal names including first, middle, and last; email addresses; mailing addresses; physical addresses; account numbers; social security numbers; birthdates; and online activities with reference at least to social media. In the illustrated example, each data set (310, 410) includes a respective profile of each user of each user group (304, 404), as once illustrated as profile 312 for example with respect to a particular user 308 of the user group 304.

The representative profile 312 documents and/or stores records 314 representing applications and software, records 316 representing services and accounts, and records 318 representing other data and digital content. Records 314 representing applications and software can include code and/or executables, and can also or otherwise include credentials and links by which use of applications and software is enabled or authorized. The services and accounts represented by records 316 can relate similarly to code and/or executables, and can relate also or otherwise to credentials and links by which services and accounts provided by the computing system 200 and/or other external systems 202 and 204 as illustrated in FIG. 1. Any and all of the records 314-318 and other elements of the profile 312 not expressly illustrated can be or can include an application, a file, a database, and a link register. A link register is broadly intended to refer to links by which use of applications and software is enabled or authorized, contact lists, login credentials, and other data and content connected to or used by the user 308 or administrators of the user group 304 or company 302 with respect to the user 308.

The records 318 in particular in at least one embodiment documents and/or stores, for the particular user 308: user names; legal name including first, middle, and last; email addresses; mailing addresses; physical addresses; account numbers; social security number; birthdate; and online activities with reference at least to social media. By use of such records, the computing system 206 can automatically postulate whether the user 308 of the pre-transition user group 304 is common to any other pre-transition user group. A probability of match is calculated in some embodiments, and when the calculated probability exceeds a threshold, a match is postulated representing a likelihood that a user of one company is the same person as a user of another company.

The computing system further, automatically at least in part, generates the combined data set 510 in the target data format by adding at least some data content of each data set in the target data format into the combined data set. For example, for each user of a particular user group may be an employee of a particular company subject to transition, the combined data set is populated with content for each unique user of what company that continues after the transition. Data format is broadly intended to refer to any protocol or storage organization for data and digital content, with reference to databases, lists, table, folders, and other arrangements by which digital holdings of an entity are organized.

Generating the combined data set in the target data format can include or be conducted by, for each unique user of the target user group, creating or maintaining a user-specific profile, the user-specific profile associating the unique user with at least one of an application, a file, a database, and a link register. Creating here refers at least to examples in which the host or first entity system 200 has no pre-transition user-specific profile for a unique user, such as can occur when one company of a merger or other transition had no previous engagement with the host or first entity system.

Maintaining here refers at least to examples in which the host or first entity system 200 has a pre-existing or pre-transition user-specific profile for a unique user, such as can occur when one company of a merger or other transition had previous engagement with the host or first entity system. In such a scenario, the existing pre-transition user-specific profile can be kept, with updates as may be preferred by any transitions planning or business rules, such that a corresponding post-transition is maintained as the pre-existing profile with updates and/or revisions as needed.

The computing system further automatically transmits a notification signal 260 to one or more agent device 212 upon at least one of: postulating one or more users of the target user group are common to more than one of the subsets of users; and completion of generating the combined data set 510 in the target data format.

The notification signal 260, when triggered by the completion of generating the combined data set in the target data format, alerts agents (210, 214) that the combined data set is ready for use by or provision to the target user group. In some instances post-merge validation is performed prior to provision to the target user group. In the example of M&A or other company transitions in which the target user group represents employees or other interested and authorized parties of the resulting organization, the combined data set 510 represents, optionally among other things, user accounts, user profiles, software applications, contact lists, and other services, functions, and access provided by or facilitated through the first entity and computing system 200.

In the illustrated example, the data set 510 includes a respective profile of each user of the target user group 504, as once illustrated as profile 512 for example with respect to a particular user 308 of the user group 504. The representative profile 512 documents and/or stores records 514 representing applications and software, records 516 representing services and accounts, and records 518 representing other data and digital content. Records 514 representing applications and software can include code and/or executables, and can also or otherwise include credentials and links by which use of applications and software is enabled or authorized. The services and accounts represented by records 516 can relate similarly to code and/or executables, and can relate also or otherwise to credentials and links by which services and accounts provided by the computing system 200 and/or other external systems 202 and 204 as illustrated in FIG. 1. Any and all of the records 514-518 and other elements of the profile 512 not expressly illustrated can be or can include an application, a file, a database, and a link register.

FIG. 2 illustrates an example in which a particular user is common to the continuing subset of user group 304 and the continuing subset of user group 404. The notification signal 260 has been triggered by the computing system automatically postulating the user 508 of the target user group 504 as common to more than one of the subsets of users as represented by user 308 of user group 304 and user 408 of user group 404. For example, the person represented as user 508 may be an employee, contractor, or other interested and authorized party of both pre-transition companies 302 and 402.

The notification signal 260, when triggered by the postulating one or more users of the target user group as common to more than one of the subsets of users, alerts agents (210, 214) that review and further evaluation can be conducted. For example, evaluating the data content of each data set of the multiple data sets further includes, in some embodiments, for each user automatically postulated as common to more than one of the subsets of users, determining whether the user postulated as common is common to more than one of the subsets.

The determining in some embodiments includes at least one of: transmitting a confirmation request to a user device associated with the user postulated as common via at least one contact channel defined by at least one data set of the multiple data sets; comparing at least two of first name, last name, and email address stored in at least two data sets of the multiple data sets; and transmitting a confirmation request to a user device associated with an authorized administrator via at least one contact channel defined by at least one data set of the multiple data sets. For example, an authorized administrator of one or more of the user groups corresponding to the data sets for which a user postulated as common can be contacted to confirm the user identity, in which case the confirmation request may be sent externally with respect to the system 200, for example via the network 258. In another example, an agent 210 involved in handling the transition is sent a confirmation request, in which case the confirmation request may be sent internally with respect to the system 200.

When evaluating the data content of each data set of the multiple data sets determines one or more users of the target user group are common to more than one of the subsets of users, creating or maintaining a user-specific profile for each unique user of the target user group includes, for each one user of the one or more users determined common, creating or maintaining a single user-specific profile. For example as illustrated in FIG. 2, once a determination is made that the user 508 of the target user group 504 is same individual as the by user 308 of user group 304 and user 408 of user group 404, a single profile 512 is created or maintained.

In a scenario in which the first user group 304 and second user group 404 each had no previous or pre-transition engagement with the host or first entity system 200, the single profile 512 created for the user 508. In a scenario in which the first user group 304 and/or second user group 404 had previous or pre-transition engagement with the host or first entity system 200, the profile 312 and/or profile 412 may pre-exist the transition, such that either or both profiles 312 and 412 are essentially maintained, with updates and/or revisions as needed.

Whether created or maintained, the user-specific profile for each unique user of the target user group can include content from any pre-existing profiles and/or other content and records pertaining to the user with reference to pre-transition information, content, settings, and access authorizations, documents, records, applications and software, services and accounts, and other data and digital content pertinent to the target user group and continuing post-transition company 502. Each user-specific profile created or maintained for each unique user of the target user group can include a user identification code unique to the unique user, for example within the records 518 representing other data and digital content for the unique user, for identity recognition and data management and clerical purposes.

Accordingly, the above-described devices and systems are advantageous in merging and managing user profiles, for example when merging companies and potentially separating companies and users to effectively manage the services acquired from or provided by a first entity. Methods are facilitated for combining and separating multiple company and user profiles to allow commercial customers to effectively manage, for example, their banking services.

A company consisting of one working unit or many working units may need flexibility in how it transitions to merge with another company or multiple other companies. A company may be re-organized. Transition may result in less continuing units, more continuing units, or restructured units. Continuity for some or all users can maintain workflow and efficiency by, for example, minimizing retraining. A subsidiary, work unit, or group of work units might need to have things set up differently in one or more work application.

It may be preferred to have things set up together. In one example, a company, work unit, or user may have five services, two services of which would be under one established profile and the other three services might be under another established profile. It may be preferred to keep those profiles separate. It may be preferred to combine the profiles so that the users only have to log in to one place and they don't have to log into multiple places to see all of the different underlying applications that they have or use.

Automated processes implemented as systems and methods described herein, are helpful during merger and acquisition (M&A) activities and divestitures. The processes are designed to address risks to organizations, including but not limited to operations, strategic, and reputational risks as a framework is established for an upcoming M&A scenario. The process includes a set of components to streamline the commercial merge profile process. The components include data preparation, pre-merge validation, merger, post-merge validation, and notifications. These components are detailed in these descriptions each according to at least one embodiment, and are represented as method steps in a flow chart in FIG. 3, which represents a method 600 for merging multiple data sets associated with respective multiple user groups by summation and transformation into a combined data set in a target data format.

Data preparation is represented as a method step 602. This component involves reviewing the company and user level data to ensure that all of the requirements necessary for merging are met.

While some transition process may be manual, automation is implemented to streamline transitions and regularize results. In the example of two companies merging as represented for example in FIG. 2, a review of the information from the two companies may be conducted, at least in part by automated process to confirm that users, work units, or other company components are accurately aligned, identified, and/or correlated

Pre-Merge Validation is represented as a method step 604. This component ensures that like users are identified and only active users are considered for merging. The Pre-Merge Validation is conducted to confirm or decide which company is going to be surviving, and which one is going to be dissolving so that underlying applications can be moved, maintained, and which ones stay. This and other information is accumulated and put in a table, and that table is the driver process for conducting a merger. Once the dissolving and surviving companies have been identified, data is then gathered and loaded into the driver table so that the merge process can begin. Validation is conducted in some embodiments of systems and methods described herein to confirm where those profiles need to be merged or not.

The merge is represented as a method step 606. This component is the core part of this process that merges company and user level data within the target system. If needed, it could also be configured to separate company and user level information. This component is capable of addressing the following scenarios:

Same users—User identities are reviewed to confirm, for example, whether the users are the same or not, because there may be respective profiles and/or data fields in data objects with reference to both a Bob Smith and William Smith, which may or may not be the same person. If the same user exists in two separate companies based on first name, last name, and email address, all the accounts and applications held by the user in the dissolving company are merged with the accounts and applications held by the user in the surviving company, for example as represented in FIG. 2 and detailed according to at least one embodiment in the corresponding descriptions.

Associated entities—If the dissolving company has an associated entity, then that same associated entity will be added to the surviving company.

Applications and Accounts—If the dissolving company has applications and accounts not available in the surviving company, then those applications and accounts will be added to the surviving company. This component triggers the appropriate notification informing the transitions team, for example with reference to agents (210, 214), of the overall status of the process which will enable them to follow up with the commercial customer after the merge process to ensure that everything worked as expected.

Separate Users—If the client needs separate or new users then new user profiles will be created and their applications and accounts would be unassigned and reassigned as needed.

Post-Merge Validation is represented as a method step 608. This component ensures that all relevant data has been merged according to the requirement specifications and business logic. This includes manual, automated and business validation. The automated validation includes a component to validate each user in the database (DB) and in the user interface (UI) where they would interact on a daily basis. The database validation may be quicker to validate in terms of establishing confidence that it conforms to the requirements. The UI validation may take more time based on the number of companies and users being merged. The automated process in some embodiments simulates the user's behavior as they navigate through the various tabs in the application to ensure that the data represents the expected results based on the business expectations. Validation is conducted to confirm that everything was combined appropriately. For any users common to more than one pre-existing group, for which combination is needed, validation verifies that they have the sum total of their accounts and applications that they had in the individual companies or pre-transitions units. If a new user is added to a group, validation assures that each new user has all of the accounts and the applications that they need and/or had in a dissolving company. Already associated entities are accommodated. Any underlying applications actively used by any company in a merger or transition, including those used by the dissolving company if they are to used post-transition, need to be available to the surviving company to be assigned to the appropriate users. Some manual assistance may be provided to automated validation components that verify everything is merged correctly.

Notifications are represented as a method step 610. This component triggers the appropriate notification informing the transitions team, for example with reference to agents (210, 214), of the overall status of the process which will enable them to follow up with the commercial customer after the merge process to ensure that everything worked as expected.

The automatically transmitted notification signal 260 is triggered by the computing system automatically postulating the user 508 of the target user group 504 as common to more than one of the subsets of users for which a data set merger is being conducted. This addresses a data set structuring and computer configuring challenge of alerting an agent with time sensitive information as a combined data set is generated, enabling a timely completion of a data set merger without duplication of user data and consequent communication inefficiency and confusion that could otherwise occur if, for example, multiple profiles for a single user were created unaware to a target user group.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

1. A system for merging multiple data sets associated with respective multiple user groups by summation and transformation into a combined data set in a target data format, each data set of multiple data sets being associated with a respective unique one user group of the multiple user groups, the combined data set associated with a target user group including subsets of users, each subset of users being a subset of one user group of the multiple user groups, the system comprising:
a computing system including at least one processor configured to execute computer-readable instructions, at least one of a memory device and a non-transitory storage device, and a communication interface for operatively connecting, via a communication network, the at least one processor to one or more agent device, wherein, upon execution of the computer-readable instructions, the at least one processor is configured to:
configure data content of each data set of the multiple data sets into the target data format;
automatically evaluate the data content of each data set of the multiple data sets to automatically postulate whether one or more users of the target user group are common to more than one of the subsets of users;
automatically generate a combined data set in the target data format by adding at least some data content of each data set in the target data format into the combined data set; and
upon postulating one or more users of the target user group are common to more than one of the subsets of users:
automatically transmit a notification signal to the one or more agent device; and
for each user automatically postulated as common to more than one of the subsets of users, determine whether the user postulated as common is common to more than one of the subsets by at least automatically transmitting a confirmation request to a user device associated with an authorized administrator via at least one contact channel defined by at least one data set of the multiple data sets.

2. The system of claim 1, wherein upon execution of the computer-readable instructions, the at least one processor is configured to generate the combined data set in the target data format by adding at least some data content of each data set in the target data format into the combined data set and by, for each unique user of the target user group, at least one of creating or maintaining a user-specific profile, the user-specific profile associating the unique user with at least one of an application, a file, a database, and a link register.

3. The system of claim 2, wherein upon execution of the computer-readable instructions, the at least one processor is configured to evaluate the data content of each data set of the multiple data sets by at least, for each user automatically postulated as common to more than one of the subsets of users, determining whether the user postulated as common is common to more than one of the subsets, the determining comprising:
transmitting a confirmation request to a user device associated with the user postulated as common via at least one contact channel defined by at least one data set of the multiple data sets; and
comparing at least two of first name, last name, and email address stored in at least two data sets of the multiple data sets.

4. The system of claim 3, wherein, when evaluating the data content of each data set of the multiple data sets determines one or more users of the target user group are common to more than one of the subsets of users, creating or maintaining a user-specific profile for each unique user of the target user group comprises, for each one user of the one or more users determined common, creating or maintaining a single user-specific profile.

5. The system of claim 4, wherein the single user-specific profile comprises at least one of an application, a file, a database, and a link register from each data set associated with the user group of each subset of users to which said one user is determined common.

6. The system of claim 1, wherein the generated combined data set in the target data format comprises a user-specific profile for each user of the target user group.

7. The system of claim 6, wherein the user-specific profile created or maintained for each unique user of the target user group comprises a user identification code unique to the unique user.

8. A system for merging at least a first data set associated with a first user group and a second data set associated with a second user group into a combined data set associated with a target user group including at least a subset the first user group and a subset of the second user group, the system comprising:
a computing system of a first entity including at least one processor configured to execute computer-readable instructions, at least one of a memory device and a non-transitory storage device, and a communication interface for operatively connecting, via a communication network, the at least one processor to one or more agent device,
wherein, upon execution of the computer-readable instructions, the at least one processor is configured to:
configure data content of the first data set and data content of the second data set, each into a target data format;
automatically evaluate the first data set and second data set to determine whether a particular user of the target user group is common to the first user group and second user group;
automatically generate a combined data set in the target data format by adding at least some of the content of the first data set and some of the data content of the second data set in the target data format into the combined data set; and
upon determining the particular user of the target user group is common to the first user group and second user group:
automatically transmit a notification signal to the one or more agent device; and
automatically transmit a confirmation request to a user device associated with an authorized administrator via at least one contact channel defined by at least one of the first data set and second data set.

9. The system of claim 8, wherein upon execution of the computer-readable instructions, the at least one processor is configured to generate the combined data set in the target data format by adding at least some of the content of the first data set and some of the data content of the second data set comprises, and by for each unique user of the target user group, at least one of creating and maintaining a user-specific profile, the user-specific profile associating the unique user with at least one of an application, a file, a database, and a link register.

10. The system of claim 9, wherein upon execution of the computer-readable instructions, the at least one processor is configured to evaluate the first data set and second data set to determine whether the particular user of the target user group is common to the first user group and the second user group by:
transmitting a confirmation request to a user device associated with the particular user via at least one contact channel defined by at least one of the first data set and the second data set; and
comparing at least two of first name, last name, and email address stored in the first data set and the second data set.

11. The system of claim 10, wherein, when evaluating the first data set and the second data set determines the particular user of the target user group is common the first user group and second user group, creating or maintaining a user-specific profile for each unique user of the target user group comprises, for the particular user, creating or maintaining a single user-specific profile.

12. The system of claim 11, wherein the single user-specific profile comprises:
at least one of an application, a file, a database, and a link register from the first data set and associated with the particular user; and
at least one of an application, a file, a database, and a link register from the second data set and associated with the particular user.

13. The system of claim 8, wherein the generated combined data set in the target data format comprises a user-specific profile for each user of the target user group.

14. The system of claim 13, wherein the user-specific profile created or maintained for each unique user of the target user group comprises a user identification code unique to the unique user.

15. A method for a computing system to merge multiple data sets associated with respective multiple user groups by summation and transformation into a combined data set in a target data format, each data set of multiple data sets being associated with a respective unique one user group of the multiple user groups, the combined data set associated with a target user group including subsets of users, each subset of users being a subset of one user group of the multiple user groups, the computing system including at least one processor configured to execute computer-readable instructions, at least one of a memory device and a non-transitory storage device, and a communication interface for operatively connecting, via a communication network, the at least one processor to one or more agent device, the method comprising, upon execution of the computer-readable instructions by the at least one processor:
configuring data content of each data set of the multiple data sets into the target data format;
automatically evaluating the data content of each data set of the multiple data sets to automatically postulate whether one or more users of the target user group are common to more than one of the subsets of users;
automatically generating a combined data set in the target data format by adding at least some data content of each data set in the target data format into the combined data set; and
upon postulating one or more users of the target user group are common to more than one of the subsets of users:
automatically transmitting a notification signal to the one or more agent device; and
transmitting a confirmation request to a user device associated with an authorized administrator via at least one contact channel defined by at least one data set of the multiple data sets.

16. The method of claim 15, wherein generating the combined data set in the target data format by adding at least some data content of each data set in the target data format into the combined data set comprises, for each unique user of the target user group, at least one of creating or maintaining a user-specific profile, the user-specific profile associating the unique user with at least one of an application, a file, a database, and a link register.

17. The method of claim 16, wherein evaluating the data content of each data set of the multiple data sets further comprises, for each user automatically postulated as common to more than one of the subsets of users, determining whether the user postulated as common is common to more than one of the subsets, the determining comprising:
transmitting a confirmation request to a user device associated with the user postulated as common via at least one contact channel defined by at least one data set of the multiple data sets; and
comparing at least two of first name, last name, and email address stored in at least two data sets of the multiple data sets.

18. The method of claim 17, wherein, when evaluating the data content of each data set of the multiple data sets determines one or more users of the target user group are common to more than one of the subsets of users, creating or maintaining a user-specific profile for each unique user of the target user group comprises, for each one user of the one or more users determined common, creating or maintaining a single user-specific profile.

19. The method of claim 18, wherein the single user-specific profile comprises at least one of an application, a file, a database, and a link register from each data set associated with the user group of each subset of users to which said one user is determined common.

20. The method of claim 15, wherein:
the generated combined data set in the target data format comprises a user-specific profile for each user of the target user group; and
the user-specific profile created or maintained for each unique user of the target user group comprises a user identification code unique to the unique user.
